(19) United States
(12) Patent Application Publication
(10) Pub. No.: US 2025/0208268 A1
(43) Pub. Date: Jun. 26, 2025

(54) DISTANCE MEASUREMENT DEVICE

(71) Applicant: SONY SEMICONDUCTOR SOLUTIONS CORPORATION, KANAGAWA (JP)

(72) Inventor: TAKAHIRO KADO, KANAGAWA (JP)

(21) Appl. No.: 18/849,699

(22) PCT Filed: Mar. 27, 2023
(86) PCT No.: PCT/JP2023/012080

§ 371 Date: Sep. 23, 2024

(30) Foreign Application Priority Data
Apr. 1, 2022 (JP) 2022-062140

(51) Int. Cl. G01S 7/4863; G01S 7/484; G01S 7/4865; G01S 17/42

(52) U.S. Cl. CPC G01S 7/4863; G01S 7/484; G01S 7/4865; G01S 17/42

(57) ABSTRACT

A range in which distance measurement cannot be performed due to an influence of parallax can be narrowed.

A distance measurement device includes: a light emitting section that periodically emits a light pulse signal; a light scanning section that scans the light pulse signal within a predetermined angle range; a light receiving section including a light receiving area that receives a reflected light pulse signal reflected by an object irradiated with the light pulse signal; a distance measurement section that measures a distance of the object on the basis of a light emission timing of the light pulse signal and a light reception timing of the reflected light pulse signal; and a control section that determines whether or not to shift the light receiving area that receives the reflected light pulse signal in a predetermined direction according to the distance of the object.

### TECHNICAL FIELD

The present disclosure relates to a distance measurement device.

### BACKGROUND ART

A mechanical light detection and ranging (LiDAR) device that can be used for automated driving and the like is known. The mechanical LiDAR device includes a light scanning section that scans a light pulse signal emitted from a light emitting section. For example, a polygon mirror is used as the light scanning section (see Patent Document 1).

The polygon mirror can scan the light pulse signal emitted from the light emitting section in a predetermined direction. By scanning the light pulse signal with the polygon mirror, the scanning range can be expanded, and the distance of an object located in a wide range can be measured.

When the object is irradiated with the light pulse signal scanned by the polygon mirror, the reflected light pulse signal from the object is reflected by the polygon mirror and received by a light receiving section.

### CITATION LIST

### Patent Document

Patent Document 1: Japanese Patent Application Laid-Open No. 2021-148477

### SUMMARY OF THE INVENTION

### Problems to be Solved by the Invention

When the light emitting section and the light receiving section are disposed at distant positions, there is a possibility that the reflected light pulse signal from the object based on the light pulse signal emitted from the light emitting section cannot be received by the light receiving section due to the influence of parallax. When the light emitting section and the light receiving section are disposed close to each other, the influence of parallax can be suppressed, but actually, since an optical system or the like is disposed, the light emitting section and the light receiving section need to be disposed at a certain distance.

In a case where the object is located at a long distance, the light emitting section and the light receiving section are hardly affected by the parallax even if the light emitting section and the light receiving section are disposed apart from each other. However, in a case where the object is located at a short distance, the influence of the parallax increases, and a range in which the reflected light pulse signal based on the light pulse signal emitted from the light emitting section is not received by the light receiving section is widened.

Therefore, the present disclosure provides a distance measurement device capable of narrowing a range in which distance measurement cannot be performed due to the influence of parallax.

### Solutions to Problems

In order to solve the above problem, according to the present disclosure, there is provided a distance measurement device including:
a light emitting section that periodically emits a light pulse signal;
a light scanning section that scans the light pulse signal within a predetermined angle range;
a light receiving section including a light receiving area that receives a reflected light pulse signal reflected by an object irradiated with the light pulse signal;
a distance measurement section that measures a distance of the object on the basis of a light emission timing of the light pulse signal and a light reception timing of the reflected light pulse signal; and
a control section that determines whether or not to shift the light receiving area that receives the reflected light pulse signal in a predetermined direction according to the distance of the object.

The light emitting section and the light receiving section may be disposed to be shifted from each other in the predetermined direction, and
the control section may shift the light receiving area in the predetermined direction when the distance of the object is less than or equal to a predetermined value.

The light emitting section and the light receiving section may be disposed to be shifted from each other in the predetermined direction, and
in a case where the distance of the object is less than or equal to a predetermined value, the control section may shift the light receiving area in the predetermined direction more largely than a case where the distance of the object is larger than the predetermined value.

The light emitting section may include a plurality of light emitting elements arranged along the predetermined direction,
the plurality of light emitting elements may emit the light pulse signal while shifting a time of each of a plurality of light emitting element groups each including two or more light emitting elements arranged adjacent to each other along the predetermined direction,
the light receiving section may include a plurality of light receiving elements arranged along the predetermined direction,
the plurality of light receiving elements may receive the reflected light pulse signal based on the light pulse signal emitted by the corresponding light emitting element group in each of a plurality of light receiving element groups each including two or more light receiving elements arranged adjacent to each other along the predetermined direction, and
the control section may determine whether or not to shift positions of the plurality of light receiving element groups that receives the reflected light pulse signal along the predetermined direction according to the distance of the object.

The control section may select one of a first mode in which the positions of the plurality of light receiving element groups are shifted in the predetermined direction and a second mode in which the positions of the plurality of light receiving element groups are not shifted in the predetermined direction on the basis of a predetermined condition.

A first distance determination section that determines whether or not the distance of the object measured by the distance measurement section is less than a reference value may be further provided, and
the control section may select the first mode when the first distance determination section determines that the distance of the object is less than the reference value, and may select the second mode when the first distance determination section determines that the distance of the object is greater than or equal to the reference value.

A second distance determination section that determines whether or not the distance of the object is greater than or equal to a reference value on the basis of a moving speed of a moving body including the light emitting section, the light scanning section, the light receiving section, and the control section may be further provided, and
the control section may select the first mode when the second distance determination section determines that the distance of the object is less than the reference value, and may select the second mode when the second distance determination section determines that the distance of the object is greater than or equal to the reference value.

The control section may alternately select the first mode or the second mode every predetermined time.

The control section may select the second mode in a case where the light scanning section scans the light pulse signal within a narrow angle range narrower than the predetermined angle range based on a center angle within the predetermined angle range, and may select the first mode in a case where the light scanning section scans the light pulse signal outside the narrow angle range.

Before distance measurement by the distance measurement section is started, the control section may cause the light emitting section to emit the light pulse signal of a smaller number of times of light emission than a number of times of light emission at a time of the distance measurement by the distance measurement section, and may select the first mode or the second mode on the basis of a result of measuring the distance of the object in advance.

According to the present disclosure, there is provided a distance measurement device including:
a light emitting section that periodically emits a light pulse signal;
a light scanning section that scans the light pulse signal within a predetermined angle range;
a light receiving section including a light receiving area that receives a reflected light pulse signal reflected by an object irradiated with the light pulse signal;
a distance measurement section that measures a distance of the object on the basis of a light emission timing of the light pulse signal and a light reception timing of the reflected light pulse signal;
an acquisition section that simultaneously acquires a first electric signal received at a central portion of the light receiving area in a first direction and a second electric signal received at a position shifted in the first direction from the central portion of the light receiving area;
a determination section that determines whether or not the light reception timing of the reflected light pulse signal can be specified on the basis of the first electric signal; and
a signal selection section that selects the first electric signal or the second electric signal on the basis of a determination result of the determination section,
in which the distance measurement section detects the light reception timing of the reflected light pulse signal on the basis of the first electric signal or the second electric signal selected by the signal selection section.

The light receiving section may include a plurality of light receiving elements located within the light receiving area extending in the first direction and a second direction intersecting the first direction,
in a case where a predetermined condition is satisfied, the acquisition section simultaneously may acquire the first electric signal in response to the reflected light pulse signal received by two or more of the light receiving elements within a light receiving range extending in the second direction at a central portion of the light receiving area in the first direction and the second electric signal in response to the reflected light pulse signal received by two or more of the light receiving elements within a light receiving range extending in the second direction at a position shifted in the first direction from the central portion of the light receiving area, and
in a case where the predetermined condition is satisfied, the distance measurement section may detect the light reception timing of the reflected light pulse signal on the basis of the first electric signal or the second electric signal selected by the signal selection section.

A first distance determination section that determines whether or not the distance of the object measured by the distance measurement section is less than a reference value may be further provided, and
the predetermined condition may be satisfied in a case where the first distance determination section determines that the distance is less than the reference value.

A second distance determination section that determines whether or not the distance of the object is greater than or equal to a reference value on the basis of a moving speed of a moving body including the light emitting section, the light scanning section, and the light receiving section may be further provided, and
the predetermined condition may be satisfied in a case where the second distance determination section determines that the distance is less than the reference value.

The distance measurement section may alternately switch every predetermined time whether to detect the light reception timing of the reflected light pulse signal on the basis of the first electric signal or the second electric signal selected by the signal selection section or to detect the light reception timing of the reflected light pulse signal received by the light receiving section.

The distance measurement section may detect the light reception timing of the reflected light pulse signal received by the light receiving section in a case where the light scanning section scans the light pulse signal within a narrow angle range narrower than the predetermined angle range based on a center angle within the predetermined angle range, and may detect the light reception timing of the reflected light pulse signal on the basis of the first electric signal or the second electric signal selected by the signal selection section in a case where the light scanning section scans the light pulse signal outside the narrow angle range.

The light receiving section may include a plurality of light receiving elements located within the light receiving area extending in the first direction and a second direction intersecting the first direction,
the acquisition section may repeat a plurality of times along the second direction within the light receiving area a process of simultaneously acquiring the first electric signal in response to the reflected light pulse signal received at a central portion in the first direction of the light receiving area and the second electric signal in response to the reflected light pulse signal received at a position shifted in the first direction from the central portion in the first direction, and
the signal selection section may repeat by a number of the light receiving elements arranged in the second direction of the light receiving area a process of selecting the first electric signal or the second electric signal for each light receiving element group arranged in the first direction within the light receiving area.

The acquisition section may acquire the second electric signal by controlling the position shifted in the first direction from the central portion in the first direction for each light receiving element group arranged in the second direction within the light receiving area.

A histogram generation section that generates a histogram representing a time frequency distribution of the light reception timing of the reflected light pulse signal on the basis of the first electric signal may be further provided, and
the determination section may determine that the light reception timing of the reflected light pulse signal cannot be specified on the basis of the first electric signal in a case where the histogram is saturated.

Before distance measurement by the distance measurement section is started, the signal selection section may cause the light emitting section to emit the light pulse signal of a smaller number of times of light emission than a number of times of light emission at a time of the distance measurement by the distance measurement section, may determine whether or not the histogram is saturated, may select the first electric signal when the histogram is not saturated, and may select the second electric signal in a case where the histogram is saturated.

### BRIEF DESCRIPTION OF DRAWINGS

FIG. 1 is a block diagram illustrating a schematic configuration of a distance measurement device according to an embodiment.

FIG. 2 is a perspective view illustrating an example of a specific configuration of a light emitting section.

FIG. 3 is a diagram schematically illustrating a scanning range of a light scanning section.

FIG. 4 is a diagram schematically illustrating a correspondence relationship between a plurality of light emitting element groups and a plurality of light receiving element groups.

FIG. 5A is a diagram illustrating a first example of a histogram.

FIG. 5B is a diagram illustrating a second example of the histogram.

FIG. 6 is a diagram illustrating light receiving ranges at the time of long-distance measurement and at the time of short-distance measurement.

FIG. 7 is a block diagram illustrating a schematic configuration of a distance measurement device 1 according to a second embodiment.

FIG. 8 is a diagram illustrating a light receiving range according to the present embodiment.

FIG. 9 is a block diagram illustrating an example of a schematic configuration of a vehicle control system.

FIG. 10 is an explanatory diagram illustrating an example of installation positions of an outside-vehicle information detecting section and an imaging section.

### MODE FOR CARRYING OUT THE INVENTION

Embodiments of a distance measurement device will be described below with reference to the drawings. Although main components of the distance measurement device will be mainly described below, the distance measurement device may have components and functions that are not illustrated or described. The following description does not exclude components and functions that are not depicted or described.

### First Embodiment

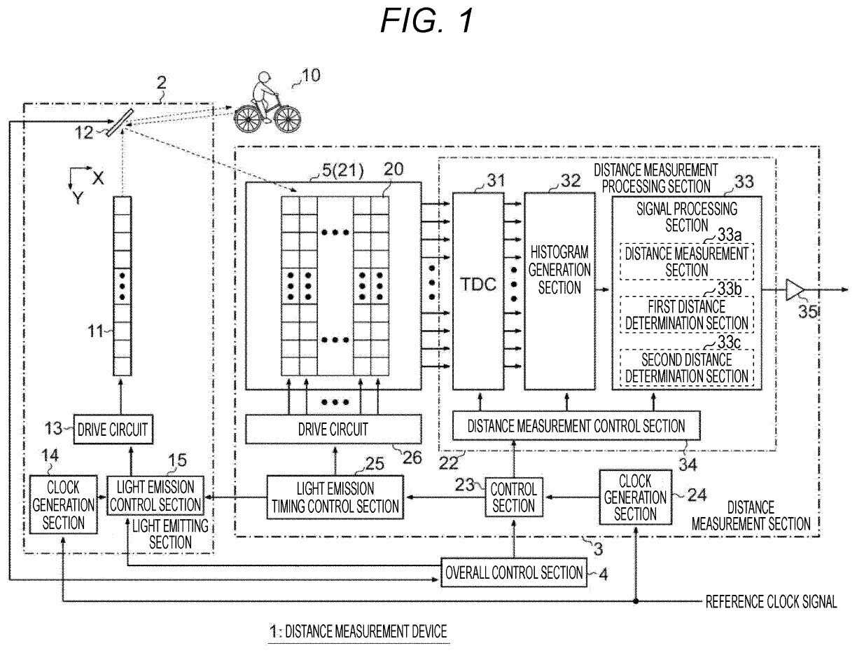

FIG. 1 is a block diagram illustrating a schematic configuration of a distance measurement device 1 according to an embodiment. The distance measurement device 1 in FIG. 1 includes a light emitting section 2, a distance measurement section 3, and an overall control section 4. The distance measurement device 1 in FIG. 1 performs distance measurement processing by a direct time of flight (dToF) method. The distance measurement section 3 includes a light receiving section 5.

The light emitting section 2 includes a plurality of light emitting elements 11, a light scanning section 12, a drive circuit 13, a clock generation section 14, and a light emission control section 15.

The plurality of light emitting elements 11 is arranged along a predetermined direction (first direction Y). In the present specification, for convenience, the first direction Y is a vertical direction, and a second direction X is a horizontal direction. Note that the first direction Y may be a horizontal direction, and the second direction X may be a vertical direction. That is, the plurality of light emitting elements 11 may be arranged in the second direction X (horizontal direction). Alternatively, the plurality of light emitting elements 11 may be arranged in the first direction Y and the second direction X.

The plurality of light emitting elements 11 repeatedly emits a light emission pulse signal (Tx pulse signal) at predetermined time intervals. The light emitting section 2 can scan the light signals emitted from the plurality of light emitting elements 11 in the first direction X. A specific method of scanning the light signals is not limited.

The light emitting element 11 is, for example, an edge emitting laser (EEL), a vertical cavity surface emitting laser (VCSEL), or the like, and the number of light emitting elements 11 included in the light emitting section 2 is arbitrary. Hereinafter, an example in which the light emitting section 2 includes a plurality of light emitting elements 11 and the plurality of light emitting elements 11 is arranged in the first direction Y will be described.

The plurality of light emitting elements 11 emits light one by one at a time shifted in order. Alternatively, among the plurality of light emitting elements 11, light may be emitted with time shifted for each light emitting element 11 group including two or more light emitting elements 11. Alternatively, the plurality of light emitting elements 11 may emit light at the same timing.

The drive circuit 13 drives the plurality of light emitting elements 11 on the basis of a control signal from the light emission control section 15. For example, the drive circuit 13 controls the light emission timing of the light pulse signal on the basis of the control signal from the light emission control section 15.

The clock generation section 14 generates a clock signal synchronized with a reference clock signal. The reference clock signal is, for example, a signal input from the outside of the distance measurement device 1. Alternatively, the reference clock signal may be generated inside the distance measurement device 1.

The light emission control section 15 generates a control signal for controlling the light emission timing of each of the light emitting elements 11 in synchronization with the clock signal. The drive circuit 13 described above drives the plurality of light emitting elements 11 on the basis of the control signal output from the light emission control section 15.

The light scanning section 12 scans the light pulse signal emitted from the light emitting section 2 within a predetermined angle range. The light scanning section 12 includes a mechanical scanning mechanism section such as a polygon mirror or a MEMS mirror, and a scanning speed of the light pulse signal fluctuates due to jitter. A specific configuration of the light scanning section 12 will be described later.

The overall control section 4 controls the light emitting section 2, the light scanning section 12, and the distance measurement section 3. The overall control section 4 may be integrated into the distance measurement section 3.

The distance measurement section 3 includes a light receiving section 5 including a pixel array section 21, a distance measurement processing section 22, a control section 23, a clock generation section 24, a light emission timing control section 25, and a drive circuit 26. The pixel array section 21 constitutes the light receiving section 5.

The pixel array section 21 includes a plurality of distance measurement pixels 20 arranged in a two-dimensional direction. The plurality of distance measurement pixels 20 receives a reflected light signal from an object 10. The plurality of distance measurement pixels 20 outputs an electric signal in response to a light intensity of the received reflected light signal.

Each of the plurality of distance measurement pixels 20 includes a light receiving element 30. The light receiving element 30 is, for example, a single photon avalanche photo diode (SPAD) 30. Each distance measurement pixel 20 may include a quench circuit (not illustrated). In the initial state, the quench circuit provides a reverse bias voltage of a potential difference that exceeds a breakdown voltage between an anode and a cathode of the SPAD 30. After the SPAD 30 detects a photon, the drive circuit 26 supplies the reverse bias voltage to the SPAD 30 via a corresponding quench circuit to prepare for detection of a next reflected light pulse signal (Rx pulse signal).

The distance measurement processing section 22 includes a time digital converter (TDC) 31, a histogram generation section 32, a signal processing section 33, and a distance measurement control section 34.

The TDC 31 generates a time digital signal in response to the light receiving time of the reflected light pulse signal received by the SPAD 30 with a predetermined time resolution. The histogram generation section 32 generates a bin width histogram in response to the time resolution of the TDC 31 on the basis of the time digital signal generated by the TDC 31. The bin width is a width of each frequency unit constituting the histogram. As the time resolution of the TDC 31 is higher, the bin width can be narrowed, and a histogram reflecting the time frequency at which the Rx pulse signal is received with higher accuracy can be obtained.

The signal processing section 33 includes a distance measurement section 33a. The distance measurement section 33a calculates a distance to the object 10 by, for example, calculating the gravity center position of the Rx pulse signal on the basis of the histogram, and outputs the distance via an output buffer 35. As will be described later, the signal processing section 33 calculates a time difference between light emission timings of the plurality of light emitting elements 11, and on the basis of the time difference, generates a correction signal for correcting the time difference between the light emission timings of the plurality of light emitting elements 11.

The control section 23 controls a processing operation of each section in the distance measurement section 3. The distance measurement control section 34 controls the TDC 31, the histogram generation section 32, and the signal processing section 33 in the distance measurement processing section 22. The light emission timing control section 25 controls the light emission control section 15 in the light emitting section 2 and controls the drive circuit 26. When a plurality of reference pixels 18 and the plurality of distance measurement pixels 20 in the pixel array section 21 detect light and the cathode voltage decreases, the drive circuit 26 performs quench control or the like to restore the cathode voltage to the original voltage.

The clock generation section 24 generates a clock signal used by the TDC 31 and the histogram generation section 32. The clock generation section 24 generates the clock signal using, for example, a PLL circuit (not illustrated).

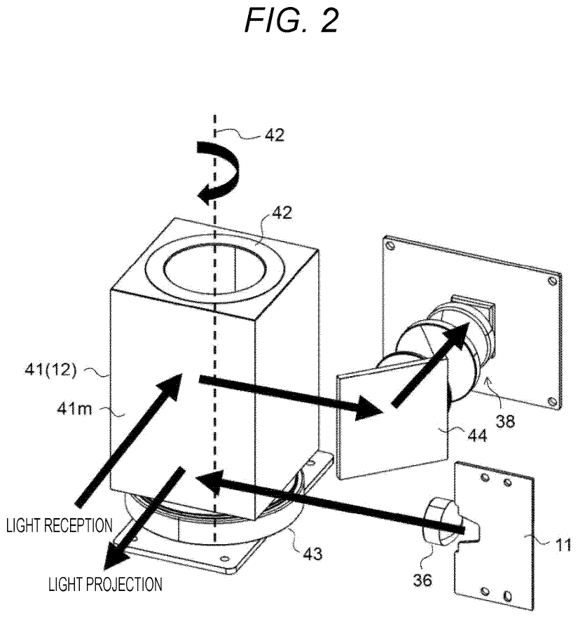

FIG. 2 is a perspective view illustrating an example of a specific configuration of the light emitting section 2, and illustrates an example in which a polygon mirror 41 is used as the light scanning section 12. As illustrated in FIG. 2, the polygon mirror 41 is rotatable about a rotation shaft 42, and the rotation shaft 42 is rotationally driven by a motor 43. The motor 43 rotates the rotation shaft 42 at a rotation speed based on a drive signal from a drive circuit (not illustrated), but the rotation speed of the rotation shaft 42 irregularly fluctuates due to jitter caused by a power supply voltage supplied to the motor 43, a temperature condition, and the like.

An outer peripheral surface of the polygon mirror 41 is a reflective mirror surface 41m, and the light pulse signal emitted from the light emitting section 2 onto the reflective mirror surface 41m propagates in a direction in response to a rotation angle of the reflective mirror surface 41m. As described above, the polygon mirror 41 continuously switches a propagation direction of the light pulse signal from the light emitting section 2 at a cycle in response to the rotation speed thereof, thereby scanning the light pulse signal in a predetermined direction (for example, in the horizontal direction).

When the object 10 is irradiated with the light pulse signal scanned by the polygon mirror 41, a reflected light pulse signal having a light intensity in response to a reflectance of the object 10 is emitted from the object 10. As illustrated in FIG. 2, the reflected light pulse signal is reflected by the polygon mirror 41 and a mirror member 44 and is incident on the light receiving section 5. Note that a reflection member that reflects the reflected light pulse signal from the object 10 may be provided separately from the polygon mirror 41.

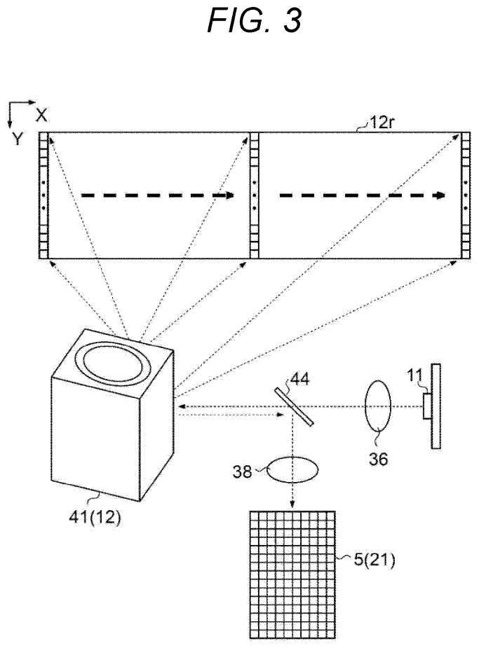

FIG. 3 is a diagram schematically illustrating a scanning range 12r of the light scanning section 12. The scanning range 12r is a two-dimensional area extending in the first direction Y and the second direction X. The first direction Y is a direction in which the plurality of light emitting elements 11 is arranged, and the second direction X is a direction in which the light scanning section 12 scans.

The light pulse signal emitted from the light emitting section 2 passes through a lens 36 and is incident on the polygon mirror 41, the propagation direction is switched, and the object 10 is irradiated with the light pulse signal. After a reflected pulse signal from the object 10 irradiated with the light pulse signal is reflected by the polygon mirror 41, the reflected pulse signal is further reflected by the mirror member 44, and received by the light receiving section 5 via a lens 37.

In this manner, the light scanning section 12 scans the light pulse signal from the light emitting section 2 along the second direction X. In the present specification, a scanning unit in the second direction X is referred to as a line. The number of scans (number of lines) in the second direction X is, for example, several tens to several thousands. The light emitting section 2 emits a plurality of light pulse signals during a period in which the light scanning section 12 scans the light pulse signal for one line. That is, a plurality of light pulse signals is emitted from the light scanning section 12 for each line scanned by the light scanning section 12.

The first direction Y of the scanning range 12r of the light scanning section 12 illustrated in FIG. 3 has the number of pixels in response to the number of the plurality of light emitting elements 11 in the light emitting section 2. As described above, the plurality of light emitting elements 11 may emit light at the same timing, or some of the plurality of light emitting elements 11 may sequentially emit light.

In the present embodiment, the plurality of light emitting elements 11 included in the light emitting section 2 can be divided into a plurality of light emitting element groups 11g, and the light emitting element groups 11g can be caused to emit light in order at shifted times. Each of the light emitting element groups 11g includes one or more light emitting elements 11, and each of the light emitting elements 11 in one light emitting element group 11g emits light at the same timing.

A reflected light pulse signal based on the light pulse signal emitted by each light emitting element 11 in each light emitting element group 11g is received by a corresponding light receiving element group in the light receiving section 5. As described above, the plurality of light receiving elements in the light receiving section 5 is divided into the plurality of light receiving element groups, and each of the light receiving element groups receives the reflected light pulse signal based on the light pulse signal emitted from the corresponding light emitting element group 11g. The reflected light pulse signal based on the light pulse signal means a reflected light pulse signal obtained by irradiating the object 10 with the light pulse signal and reflecting the light pulse signal from the object 10.

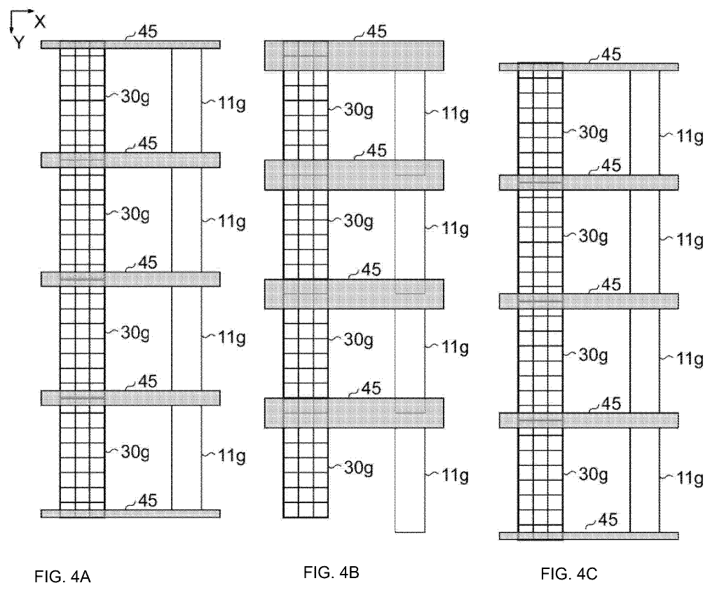

FIG. 4 is a diagram schematically illustrating a correspondence relationship between the plurality of light emitting element groups 11g and the plurality of light receiving element groups 30g. FIG. 4A illustrates a case where distance measurement of the object 10 located at a short distance is performed (at the time of short-distance measurement), and FIG. 4B illustrates a case where distance measurement of the object 10 located at a long distance is performed (at the time of long-distance measurement).

In the example of FIGS. 4A and 4B, the light emitting section 2 includes four light emitting element groups 11g (first to fourth light emitting element groups 11g1 to 11g4), and the light receiving section 5 includes four light receiving element groups 30g (first to fourth light receiving element groups 30g1 to 30g4). In FIGS. 4A and 4B, the first to fourth light receiving element groups 30g1 to 30g4 receive reflected light pulse signals based on light pulse signals emitted from the first to fourth light emitting element groups 11g1 to 11g4, respectively. Note that the number of the light emitting element groups 11g in the light emitting section 2 is arbitrary, and the light receiving element groups 30g in the light receiving section 5 are provided as many as the light emitting element groups 11g.

FIGS. 4A and 4B illustrate an example in which the first to fourth light emitting element groups 11g1 to 11g4 are arranged in the first direction Y, and the first to fourth light receiving element groups 30g1 to 30g4 are also arranged in the first direction Y. A distance measurement disabled area 45 extending in the second direction X exists in the vicinity of a boundary between the adjacent light emitting element groups 11g among the first to fourth light emitting element groups 11g1 to 11g4 and in the vicinity of a boundary between the adjacent light receiving element groups 30g among the first to fourth light receiving element groups 30g1 to 30g4. The reflected light pulse signal based on the light pulse signal emitted from the light emitting element 11 in the distance measurement disabled area 45 is not received by any light receiving element 30.

As can be seen from a comparison between FIGS. 4A and 4B, the distance measurement disabled area 45 is small at the time of short-distance measurement, whereas the distance measurement disabled area 45 is wide at the time of long-distance measurement. The reason why the distance measurement disabled area 45 is generated is that, in FIG. 2, the light emitting section 2 and the light receiving section 5 are arranged to be shifted in the first direction Y (vertical direction), and parallax is generated. At the time of the long-distance measurement, since a difference in the propagation direction of the reflected light pulse signal emitted from any light emitting element 11 in the first to fourth light emitting element groups 11g1 to 11g4 is small, most of the reflected light pulse signal can be received by any of the light receiving elements 30, and the distance measurement disabled area 45 becomes small. On the other hand, at the time of the short-distance measurement, since the difference in the propagation direction of the reflected light pulse signal emitted from any light emitting element 11 in the first to fourth light emitting element groups 11g1 to 11g4 increases, some of the reflected light pulse signals cannot be received by the first to fourth light receiving element groups 30g1 to 30g4, and the distance measurement disabled area 45 increases.

At the time of the short-distance measurement, as illustrated in FIG. 4B, some light emitting elements 11 in each of the first to fourth light emitting element groups 11g1 to 11g4 do not emit light pulse signals. This is because even if the light pulse signal is emitted, the reflected light pulse signal cannot be received by the corresponding light receiving element 30. Therefore, some light receiving elements 30 in each of the first to fourth light receiving element groups 30g1 to 30g4 cannot receive an effective reflected light pulse signal, and the entire area of the first to fourth light receiving element groups 30g1 to 30g4 cannot be effectively used for receiving the reflected light pulse signal.

FIG. 4C is a diagram illustrating an example of a measure for reducing the distance measurement disabled area 45 at the time of the short-distance measurement. In FIG. 4C, the light receiving areas of the first to fourth light receiving element groups 30g1 to 30g4 are shifted in the first direction Y at the time of the short-distance measurement. As can be seen by comparing FIG. 4C with FIG. 4B, in FIG. 4C, the first to fourth light receiving element groups 30g1 to 30g4 are shifted downward in the first direction Y (vertical direction) as compared with FIG. 4B. As a result, the distance measurement disabled area 45 at the time of the short-distance measurement can be reduced to the same extent as that at the time of the long-distance measurement.

The shift control of the light receiving areas of the first to fourth light receiving element groups 30g1 to 30g4 is performed by, for example, the control section 23 in FIG. 1. The control section 23 determines whether or not to shift the plurality of light receiving element groups 30g that receives the reflected light pulse signal along the first direction Y according to the distance of the object 10 measured by the distance measurement section 33a in the signal processing section 33.

In a case where the light emitting section 2 and the light receiving section 5 are disposed while shifted from each other in the predetermined direction (first direction Y), the control section 23 shifts the light receiving area in the predetermined direction (first direction Y) when the distance to the object 10 is less than or equal to a predetermined value. That is, in a case where the distance of the object 10 is less than or equal to the predetermined value, the control section 23 shifts the light receiving area in the predetermined direction more largely than a case where the distance of the object 10 is larger than the predetermined value.

On the basis of a predetermined condition, the control section 23 selects one of a first mode in which the positions of the plurality of light receiving element groups 30g are shifted in a predetermined direction and a second mode in which the positions of the plurality of light receiving element groups 30g are not shifted in the predetermined direction. The predetermined condition is, for example, a condition that depends on the distance of the object 10. Specifically, details are as follows. The first mode can be referred to as a short-distance measurement-oriented mode, and the second mode can be referred to as a long-distance measurement-oriented mode.

The signal processing section 33 may include a first distance determination section 33b that determines whether or not the distance of the object 10 measured by the distance measurement section 33a is less than a reference value. In this case, the control section 23 selects the first mode when the first distance determination section 33b determines that the distance of the object 10 is less than the reference value, and selects the second mode when the first distance determination section 33b determines that the distance of the object 10 is greater than or equal to the reference value.

Alternatively, the signal processing section 33 may include a second distance determination section 33c that determines whether or not the distance of the object 10 is greater than or equal to a reference value on the basis of a moving speed of a moving body such as a vehicle on which the distance measurement device 1 according to the present embodiment is mounted. In this case, the control section 23 selects the first mode when the second distance determination section 33c determines that the distance of the object 10 is less than the reference value, and selects the second mode when the second distance determination section 33c determines that the distance of the object 10 is greater than or equal to the reference value.

Alternatively, the control section 23 may alternately select the first mode or the second mode every predetermined time. In this case, since the control section 23 can select the first mode or the second mode without detecting the distance of the object 10, the processing load of the control section 23 is reduced. Furthermore, since the control section 23 can finally measure the distance of the object 10 by combining the distance measurement processing in the first mode and the distance measurement processing in the second mode, the distance measurement accuracy can be improved.

Alternatively, the control section 23 may select the second mode in a case where the light scanning section 12 scans the light pulse signal within a narrow angle range narrower than a predetermined angle range based on a center angle within the predetermined angle range, and select the first mode in a case where the light scanning section 12 scans the light pulse signal outside the narrow angle range. Since the reflected light pulse signal based on the light pulse signal emitted within the narrow angle range from the center angle is received near the center of the light receiving area in the first direction Y, the second mode is selected. On the other hand, since there is a high possibility that the reflected light pulse signal based on the light pulse signal emitted outside the narrow angle range from the center angle is received at a position shifted from the central portion of the light receiving area in the first direction Y, the first mode is selected. For example, an angular range of ±20 degrees based on the center angle may be set as the narrow angle range.

Alternatively, before the distance measurement by the distance measurement section 33a is started, the control section 23 causes the light emitting section 2 to emit a light pulse signal of a smaller number of times of light emission than that at the time of the distance measurement by the distance measurement section 33a, and selects the first mode or the second mode on the basis of a result of measuring the distance of the object 10 in advance. In this case, whether the object 10 is a short distance or a long distance is measured in advance before the distance measurement of the object 10 is started, the first mode or the second mode is selected on the basis of a result of the preliminary measurement, and the original distance measurement is started. As a result, the first mode or the second mode can be accurately selected.

As described above, in the first embodiment, since the light receiving area where the reflected light pulse signal is received can be shifted along an arrangement direction of the plurality of light receiving elements 30 according to the distance of the object 10 to be measured, the distance measurement disabled area 45 can be reduced, and the distance measurement can be performed by effectively utilizing almost the entire areas of the light emitting section 2 and the light receiving section 5. In particular, in the case of measuring the distance of the object 10 at a short distance, the distance measurement is easily affected by parallax due to the positional deviation between the light emitting section 2 and the light receiving section 5, and the distance measurement disabled area 45 may be widened. For this reason, by shifting the light receiving areas of the plurality of light receiving element groups 30g along the arrangement direction of the plurality of light receiving element groups 30g as necessary, the distance measurement disabled areas 45 at the time of the short-distance measurement and the long-distance measurement can be made substantially the same. As a result, in particular, the distance measurement disabled area 45 at the time of the short-distance measurement can be reduced.

### Second Embodiment

In the distance measurement device 1 of the dToF system illustrated in FIG. 1, an electric signal in response to the reflected light pulse signal received by the light receiving section 5 is converted into a time digital signal by the TDC 31, and then a histogram representing a time frequency distribution is generated by the histogram generation section 32. The histogram represents a time distribution of the peak position of the light intensity of the reflected light pulse signal, and is used to specify the light reception timing.

In a case where the SPAD is used as the light receiving element 30, since the SPAD can output only a binary signal indicating whether or not a photon has been detected, in order to detect the light intensity of the reflected light pulse signal, a plurality of SPADs is provided in one pixel, a histogram is generated according to whether or not each of the plurality of SPADs has detected a photon, and the light intensity is detected. However, since each SPAD is saturated with a small amount of light, a dynamic range of the histogram is narrowed. The narrow dynamic range of the histogram means that the light reception timing cannot be accurately specified.

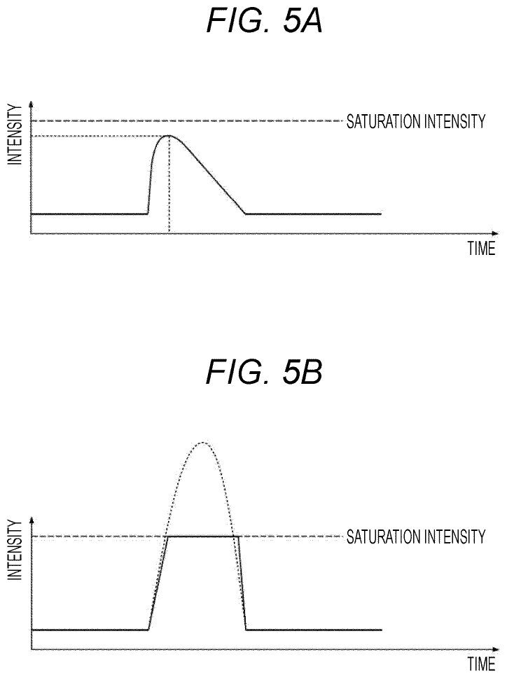

FIG. 5A is a diagram illustrating a first example of the histogram, and illustrates an example in which the histogram is not saturated. Since the signal intensity at a peak position of the histogram in FIG. 5A is lower than the saturation intensity, the light reception timing can be specified by the peak position of the histogram.

FIG. 5B is a diagram illustrating a second example of the histogram, and illustrates an example in which the histogram is saturated. A peak position of the histogram indicated by the solid line in FIG. 5B is clipped with saturation intensity, and the original peak position indicated by the broken line cannot be found. Therefore, the light reception timing cannot be specified from the histogram indicated by the solid line in FIG. 5B.

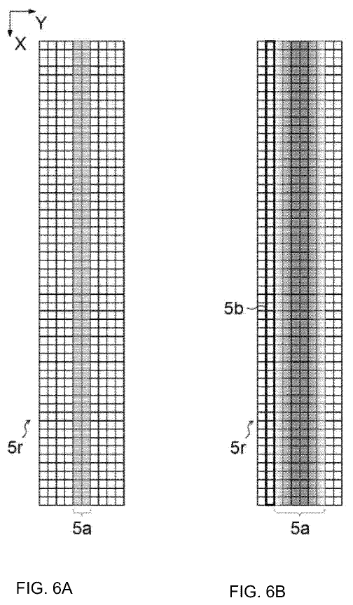

In the distance measurement device 1, optical design is performed so that most reflected light pulses can be received in the light receiving area in the light receiving section 5. FIG. 6 is a diagram illustrating light receiving ranges at the time of long-distance measurement and at the time of short-distance measurement, FIG. 6A is a diagram illustrating a light receiving range 5a of a reflected light pulse signal at the time of long-distance measurement, and FIG. 6B is a diagram illustrating a light receiving range 5a of a reflected light pulse signal at the time of short-distance measurement.

When the distance measurement device 1 is designed, optical adjustment is generally performed so that distance measurement accuracy at the time of long-distance measurement is improved. More specifically, as illustrated in FIG. 6A, the distance measurement device 1 performs optical adjustment so that the reflected light pulse signal is received near the central pixel of each line extending in the first direction Y in a light receiving area 5r of the light receiving section 5. The example of FIG. 6A illustrates an example in which the reflected light pulse signal is received in the light receiving ranges 5a of two pixels on the center side of each line within the light receiving area 5r. Since the light intensity of the reflected light pulse signal received at the time of long-distance measurement is not so high, the peak position of the histogram does not exceed the saturation intensity as illustrated in FIG. 5B when the histogram is generated.

On the other hand, when the long-distance measurement is performed using the distance measurement device 1 optically adjusted in accordance with the long-distance measurement as illustrated in FIG. 6A, the light receiving range 5a of the reflected light pulse signal is widened as illustrated in FIG. 6B. At the time of short-distance measurement, the light intensity of the reflected light pulse signal is larger than that at the time of long-distance measurement. For this reason, in particular, when a histogram is generated on the basis of the pixels in the central portion of each line in the light receiving area 5r, the peak position of the histogram exceeds the saturation intensity, and is clipped as illustrated in FIG. 5B. Therefore, the light reception timing cannot be accurately specified from the histogram, and the distance measurement accuracy decreases. Therefore, in the present embodiment, the distance measurement accuracy at the time of short-distance measurement is improved.

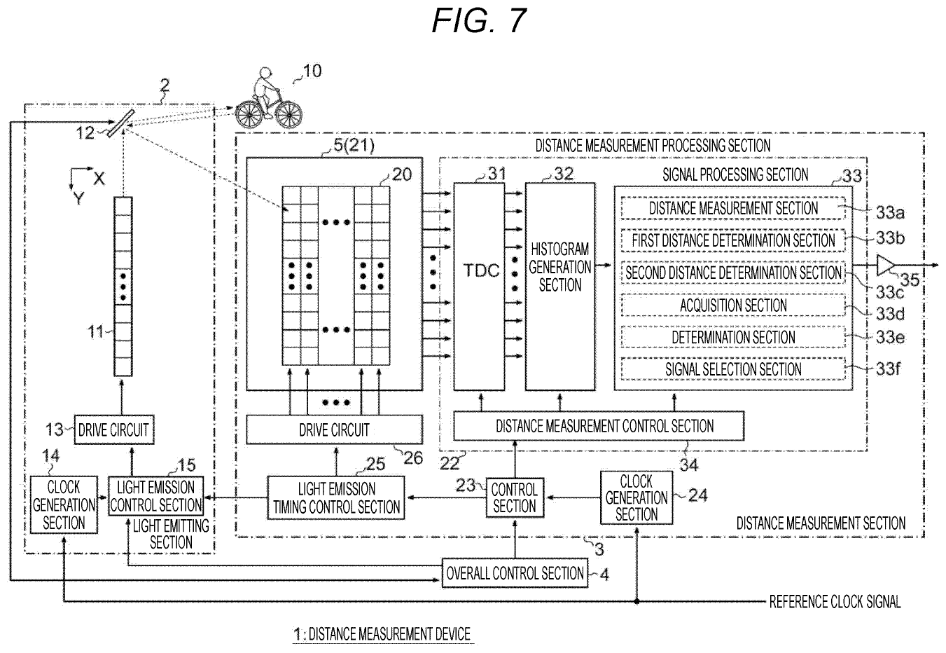

FIG. 7 is a block diagram illustrating a schematic configuration of a distance measurement device 1 according to a second embodiment. The distance measurement device 1 of FIG. 7 is configured similarly to the distance measurement device 1 of FIG. 1 except that a processing operation of a signal processing section 33 is partially different from a processing operation of the signal processing section 33 in the distance measurement device 1 of FIG. 1. The signal processing section 33 in FIG. 7 includes a distance measurement section 33a, an acquisition section 33d, a determination section 33e, and a signal selection section 33f.

When a predetermined condition is satisfied, specifically, at the time of short-distance measurement, the acquisition section 33d simultaneously acquires a first electric signal received at the central portion of the light receiving area 5r of the light receiving section 5 and a second electric signal received at a position shifted from the central portion of the light receiving area 5r. More specifically, at the time of short-distance measurement, the acquisition section 33d simultaneously acquires the first electric signal received by the pixel in the central portion of the line extending in the first direction Y within the light receiving area 5r and the second electric signal received by the pixel in the position shifted from the central portion on the same line. Reflected light pulse signals based on the light pulse signals from the plurality of light emitting elements 11 emitted at the same light emission timing are received by the plurality of pixels on the same line. Therefore, the first electric signal and the second electric signal acquired by the acquisition section 33d are two reflected light pulse signals obtained by reflecting, by the object 10, the light pulse signals emitted by the two light emitting elements 11 on the same line at the same time.

How many pixels are shifted in a line direction from the central pixel of each line within the light receiving area 5r to generate the second electric signal is arbitrary. For example, it is conceivable that the second electric signal is sequentially generated by pixels at positions shifted by one pixel from the center pixel to check whether or not the histogram is saturated, and the pixel position closest to the center pixel at which the histogram is not saturated is finally selected to generate the second electric signal.

The determination section 33e determines whether or not the light reception timing of the reflected light pulse signal can be specified on the basis of the first electric signal. Specifically, in a case where the peak position of the histogram generated on the basis of the first electric signal is saturated, the determination section 33e determines that the light reception timing of the reflected light pulse signal cannot be specified on the basis of the first electric signal.

The signal selection section 33f selects the first electric signal or the second electric signal on the basis of a determination result of the determination section 33e. More specifically, at the time of short-distance measurement, the signal selection section 33f selects the first electric signal in a case where the peak position of the histogram generated on the basis of the first electric signal is not saturated, and selects the second electric signal in a case where the peak position of the histogram generated on the basis of the first electric signal is saturated. The second electric signal is generated on the basis of, for example, a pixel group 5b extending in the second direction X at a pixel position shifted from the central portion in the first direction Y within the light receiving area 5r in FIG. 6B.

At the time of short-distance measurement, the distance measurement section 33a detects the light reception timing of the reflected light pulse signal on the basis of the first electric signal or the second electric signal selected by the signal selection section 33f.

The acquisition section 33d and the signal selection section 33f perform the above-described processing operation only at the time of short-distance measurement, and stop the processing operation at the time of long-distance measurement. At the time of long-distance measurement, as illustrated in FIG. 6A, since the light receiving range 5a is narrow and the light intensity of the reflected light pulse signal is weak, it is not necessary to take measures against saturation of the histogram. Therefore, at the time of long-distance measurement, as illustrated in FIG. 6A, the distance measurement section 33a generates a histogram by the histogram generation section 32 on the basis of the reflected light pulse signal received by the central pixel of each line within the light receiving area 5r, determines the light reception timing from the generated histogram, and measures the distance of the object 10.

The distance measurement device 1 of FIG. 7 may determine whether or not the predetermined condition is satisfied by a processing procedure similar to that of the distance measurement device 1 of FIG. 1. The case where the predetermined condition is satisfied is, for example, a case where short-distance measurement is performed. More specifically, a first distance determination section 33b that determines whether or not the distance of the object 10 measured by the distance measurement section 33a is greater than or equal to a reference value may be provided in the signal processing section 33, and whether to perform the processing operation of the short-distance measurement or the processing operation of the long-distance measurement may be determined on the basis of the determination result of the first distance determination section 33b. Furthermore, the signal processing section 33 of FIG. 1 may include a second distance determination section 33c that determines whether or not the distance of the object 10 is greater than or equal to a reference value on the basis of a moving speed of a moving body such as a vehicle on which the distance measurement device 1 according to the present embodiment is mounted.

Furthermore, the signal processing section 33 may alternately select the processing operation of the short-distance measurement or the long-distance measurement every predetermined time. Furthermore, the signal processing section 33 may perform the processing operation of long-distance measurement while the light scanning section 12 scans the light pulse signal within a narrow angle range based on the center angle, and may perform the processing operation of short-distance measurement while the light scanning section 12 cancels the light pulse signal outside the narrow angle range based on the center angle. Moreover, in the distance measurement device 1 of FIG. 7, before starting the original distance measurement process, it may be determined whether to perform the processing operation of the short-distance measurement or the long-distance measurement with a smaller number of times of light emission than the original distance measurement process.

As described above, in the second embodiment, in a case where the histogram is saturated at the central portion of each line in the light receiving area 5r at the time of short-distance measurement, the light reception timing is specified on the basis of the reflected light pulse signal received by the light receiving element 30 at a position shifted from the central portion of each line. As a result, the distance measurement accuracy at the time of short-distance measurement can be improved.

### Third Embodiment

In a third embodiment, a pixel position used for distance measurement is changed for each portion of the light receiving area 5r.

A distance measurement device 1 according to the third embodiment has a block configuration similar to that in FIG. 7, but processing operations of an acquisition section 33d and a signal selection section 33f are different from those in the second embodiment.

A light receiving section 5 in the distance measurement device 1 according to the third embodiment includes a plurality of light receiving elements 30 arranged in the first direction Y and the second direction X. The acquisition section 33d repeats processing of simultaneously acquiring a first electric signal in response to the reflected light pulse signal received at the central portion in the first direction Y of a light receiving area 5r and a second electric signal in response to the reflected light pulse signal received at the position shifted in the first direction Y from the central portion in the first direction Y a plurality of times along the second direction X in the light receiving area 5r.

The signal selection section 33f repeats processing of selecting the first electric signal or the second electric signal for each of light receiving element groups 30g arranged in the first direction Y within the light receiving area 5r by the number of light receiving elements 30 arranged in the second direction X in the light receiving area 5r.

A distance measurement section 33a determines the light reception timing on the basis of the electric signal selected by the signal selection section 33f, and measures the distance of the object 10.

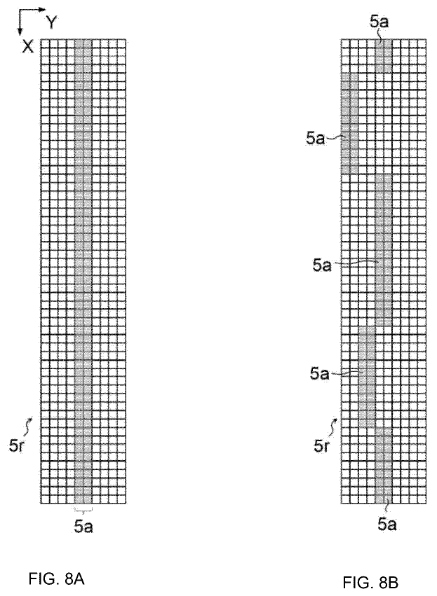

FIG. 8 is a diagram illustrating a light receiving range 5a according to the present embodiment, and FIG. 8A is a diagram illustrating a light receiving range 5a of a reflected light pulse signal received by the light receiving area 5r at the time of long-distance measurement. In the distance measurement device 1 according to the third embodiment, similarly to the second embodiment, adjustment is performed such that the reflected light pulse signal is received in the vicinity of the central pixel of each line of the light receiving area 5r at the time of long-distance measurement.

Actually, since the position of the object 10 that is a distance measurement target can change, the reflected light pulse signal is not necessarily received at the pixel position in FIG. 8A.

FIG. 8B is a diagram illustrating a pixel position selected by the signal selection section 33f in the distance measurement device 1 according to the third embodiment. As illustrated in the drawing, the signal selection section 33f selects either a central pixel or a pixel shifted from the center for each line extending in the first direction Y within the light receiving area 5r. As a result, the pixel position selected by the signal selection section 33f along the second direction X within the light receiving area 5r can change for each line.

A histogram generation section 32 generates a histogram on the basis of the reflected light pulse signal received at the pixel position selected by the signal selection section 33f. The distance measurement section 33a determines the light reception timing on the basis of the histogram generated by the histogram generation section 32, and measures the distance of the object 10.

Similarly to the second embodiment, the signal selection section 33f selects a pixel position at which a peak position of the histogram is the saturation intensity or less. Therefore, by generating the histogram on the basis of the reflected light pulse signal received by the pixel selected by the signal selection section 33f, the light reception timing can be accurately specified from the peak position of the generated histogram.

Before the distance measurement by the distance measurement section 33a is started, the signal selection section 33f causes a light emitting section 2 to emit a light pulse signal of a smaller number of times of light emission than that at the time of the distance measurement by the distance measurement section 33a, determines whether or not the histogram is saturated, selects the first electric signal when the histogram is not saturated, and selects the second electric signal in a case where the histogram is saturated.

As described above, in the third embodiment, the processing of simultaneously acquiring the first electric signal in response to the reflected light pulse signal received at the central portion of each line within the light receiving area 5r of the light receiving section 5 and the second electric signal in response to the reflected light pulse signal received at the position shifted from the central portion in the line direction, and selecting the first electric signal or the second electric signal is repeated along the second direction X within the light receiving area 5r. As a result, for each line within the light receiving area 5r, the histogram can be generated on the basis of the reflected light pulse signal at the position where the histogram is not saturated to measure the distance of the object 10, and the accuracy of distance measurement can be improved.

### Application Example

The technology according to the present disclosure can be applied to various products. For example, the technology according to the present disclosure may also be implemented as a device mounted on any kind of moving body such as an automobile, an electric automobile, a hybrid electric automobile, a motorcycle, a bicycle, a personal mobility, an airplane, a drone, a ship, a robot, a construction machine, an agricultural machine (tractor), or the like.

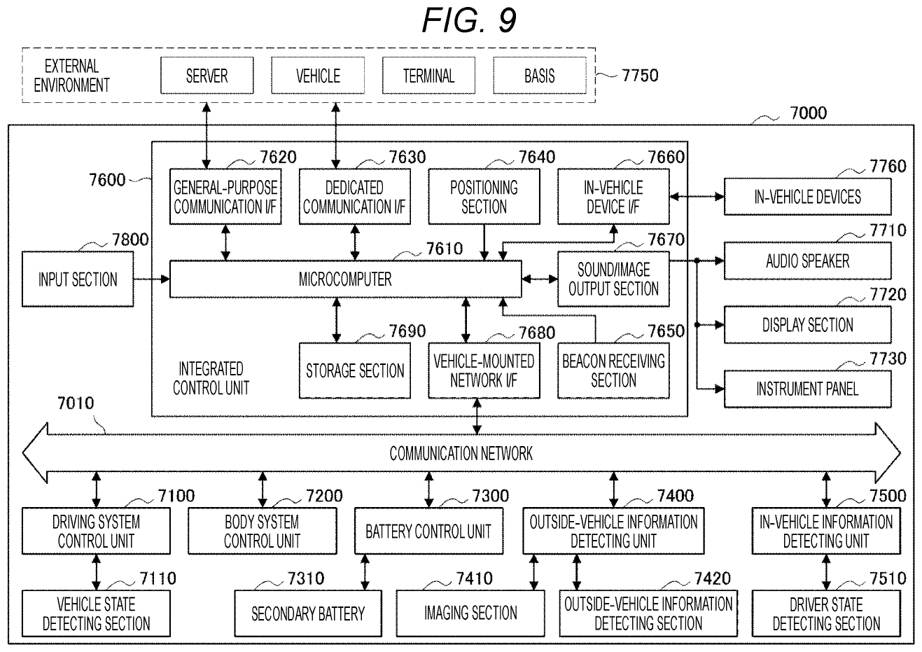

FIG. 9 is a block diagram illustrating a schematic configuration example of a vehicle control system 7000 that is an example of a moving body control system to which the technology according to the present disclosure can be applied. The vehicle control system 7000 includes a plurality of electronic control units connected to each other via a communication network 7010. In the example illustrated in FIG. 9, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. In FIG. 9, as a functional configuration of the integrated control unit 7600, a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690 are illustrated. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, an amount of charge remaining in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

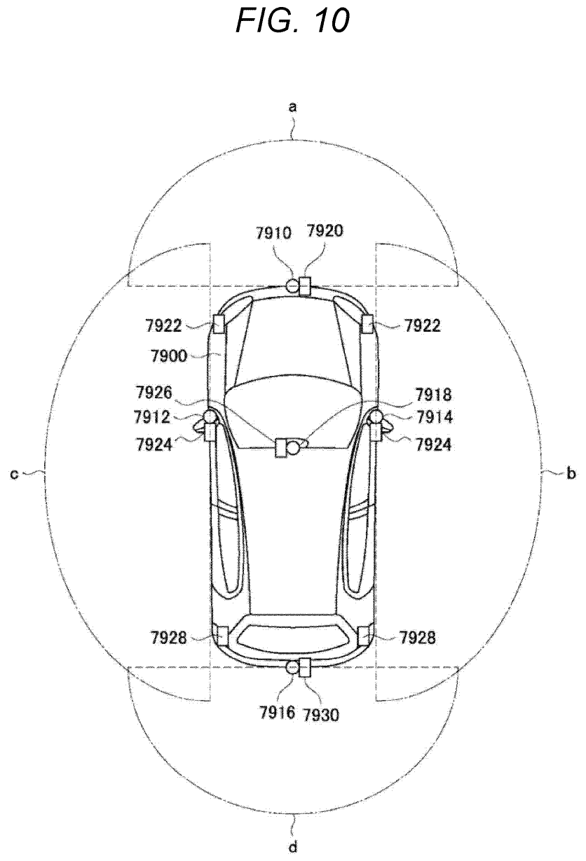

Here, FIG. 10 illustrates an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, and a back door of the vehicle 7900 and a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided to the sideview mirrors obtain mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Note that FIG. 10 illustrates an example of imaging ranges of the respective imaging sections 7910, 7912, 7914, and 7916. An imaging range a represents the imaging range of the imaging section 7910 provided to the front nose. Imaging ranges b and c respectively represent the imaging ranges of the imaging sections 7912 and 7914 provided to the sideview mirrors. An imaging range d represents the imaging range of the imaging section 7916 provided to the rear bumper or the back door. A bird's-eye image of the vehicle 7900 as viewed from above can be obtained by superimposing image data imaged by the imaging sections 7910, 7912, 7914, and 7916, for example.

Outside-vehicle information detecting sections 7920, 7922, 7924, 7926, 7928, and 7930 provided to the front, rear, sides, and corners of the vehicle 7900 and the upper portion of the windshield within the interior of the vehicle may be, for example, an ultrasonic sensor or a radar device. The outside-vehicle information detecting sections 7920, 7926, and 7930 provided to the front nose of the vehicle 7900, the rear bumper, the back door of the vehicle 7900, and the upper portion of the windshield within the interior of the vehicle may be a LIDAR device, for example. These outside-vehicle information detecting sections 7920 to 7930 are used mainly to detect a preceding vehicle, a pedestrian, an obstacle, or the like.

Returning to FIG. 9, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 9, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Note that, in the example illustrated in FIG. 9, at least two control units connected via the communication network 7010 may be integrated as one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Note that a computer program for implementing each function of the distance measurement device 1 according to the present embodiment described with reference to FIG. 1 and the like can be implemented in any of the control units or the like. Furthermore, a computer-readable recording medium in which such a computer program is stored can be provided. The recording medium is, for example, a magnetic disk, an optical disk, a magneto-optical disk, a flash memory, or the like. Furthermore, the computer program described above may be distributed via, for example, a network without using a recording medium.

In the vehicle control system 7000 described above, the distance measurement device 1 according to the present embodiments described with reference to FIG. 1 and the like can be applied to the integrated control unit 7600 of the application example illustrated in FIG. 9.

Furthermore, at least some components of the distance measurement device 1 described with reference to FIG. 1 and the like may be realized in a module (for example, an integrated circuit module including one die) for the integrated control unit 7600 illustrated in FIG. 9. Alternatively, the distance measurement device 1 described with reference to FIG. 1 may be realized by a plurality of control units of the vehicle control system 7000 illustrated in FIG. 9.

Note that the present technology may have the following configurations.
(1) A distance measurement device including:
a light emitting section that periodically emits a light pulse signal;
a light scanning section that scans the light pulse signal within a predetermined angle range;
a light receiving section including a light receiving area that receives a reflected light pulse signal reflected by an object irradiated with the light pulse signal;
a distance measurement section that measures a distance of the object on the basis of a light emission timing of the light pulse signal and a light reception timing of the reflected light pulse signal; and
a control section that determines whether or not to shift the light receiving area that receives the reflected light pulse signal in a predetermined direction according to the distance of the object.
(2) The distance measurement device according to (1), in which
the light emitting section and the light receiving section are disposed to be shifted from each other in the predetermined direction, and
the control section shifts the light receiving area in the predetermined direction when the distance of the object is less than or equal to a predetermined value.
(3) The distance measurement device according to (1) or (2), in which
the light emitting section and the light receiving section are disposed to be shifted from each other in the predetermined direction, and
in a case where the distance of the object is less than or equal to a predetermined value, the control section shifts the light receiving area in the predetermined direction more largely than a case where the distance of the object is larger than the predetermined value.
(4) The distance measurement device according to any one of (1) to (3), in which
the light emitting section includes a plurality of light emitting elements arranged along the predetermined direction,
the plurality of light emitting elements emits the light pulse signal while shifting a time of each of a plurality of light emitting element groups each including two or more light emitting elements arranged adjacent to each other along the predetermined direction,
the light receiving section includes a plurality of light receiving elements arranged along the predetermined direction,
the plurality of light receiving elements receives the reflected light pulse signal based on the light pulse signal emitted by the corresponding light emitting element group in each of a plurality of light receiving element groups each including two or more light receiving elements arranged adjacent to each other along the predetermined direction, and
the control section determines whether or not to shift positions of the plurality of light receiving element groups that receives the reflected light pulse signal along the predetermined direction according to the distance of the object.
(5) The distance measurement device according to (4), in which
the control section selects one of a first mode in which the positions of the plurality of light receiving element groups are shifted in the predetermined direction and a second mode in which the positions of the plurality of light receiving element groups are not shifted in the predetermined direction on the basis of a predetermined condition.
(6) The distance measurement device according to (5), further including
a first distance determination section that determines whether or not the distance of the object measured by the distance measurement section is less than a reference value,
in which the control section selects the first mode when the first distance determination section determines that the distance of the object is less than the reference value, and selects the second mode when the first distance determination section determines that the distance of the object is greater than or equal to the reference value.
(7) The distance measurement device according to (5), further including
a second distance determination section that determines whether or not the distance of the object is greater than or equal to a reference value on the basis of a moving speed of a moving body including the light emitting section, the light scanning section, the light receiving section, and the control section,
in which the control section selects the first mode when the second distance determination section determines that the distance of the object is less than the reference value, and selects the second mode when the second distance determination section determines that the distance of the object is greater than or equal to the reference value.
(8) The distance measurement device according to (5), in which
the control section alternately selects the first mode or the second mode every predetermined time.
(9) The distance measurement device according to (5), in which
the control section selects the second mode in a case where the light scanning section scans the light pulse signal within a narrow angle range narrower than the predetermined angle range based on a center angle within the predetermined angle range, and selects the first mode in a case where the light scanning section scans the light pulse signal outside the narrow angle range.
(10) The distance measurement device according to (5), in which
before distance measurement by the distance measurement section is started, the control section causes the light emitting section to emit the light pulse signal of a smaller number of times of light emission than a number of times of light emission at a time of the distance measurement by the distance measurement section, and selects the first mode or the second mode on the basis of a result of measuring the distance of the object in advance.
(11) A distance measurement device including:
a light emitting section that periodically emits a light pulse signal;
a light scanning section that scans the light pulse signal within a predetermined angle range;
a light receiving section including a light receiving area that receives a reflected light pulse signal reflected by an object irradiated with the light pulse signal;
a distance measurement section that measures a distance of the object on the basis of a light emission timing of the light pulse signal and a light reception timing of the reflected light pulse signal;
an acquisition section that simultaneously acquires a first electric signal received at a central portion of the light receiving area in a first direction and a second electric signal received at a position shifted in the first direction from the central portion of the light receiving area;
a determination section that determines whether or not the light reception timing of the reflected light pulse signal can be specified on the basis of the first electric signal; and
a signal selection section that selects the first electric signal or the second electric signal on the basis of a determination result of the determination section,
in which the distance measurement section detects the light reception timing of the reflected light pulse signal on the basis of the first electric signal or the second electric signal selected by the signal selection section.
(12) The distance measurement device according to (11), in which
the light receiving section includes a plurality of light receiving elements located within the light receiving area extending in the first direction and a second direction intersecting the first direction,
in a case where a predetermined condition is satisfied, the acquisition section simultaneously acquires the first electric signal in response to the reflected light pulse signal received by two or more of the light receiving elements within a light receiving range extending in the second direction at a central portion of the light receiving area in the first direction and the second electric signal in response to the reflected light pulse signal received by two or more of the light receiving elements within a light receiving range extending in the second direction at a position shifted in the first direction from the central portion of the light receiving area, and
in a case where the predetermined condition is satisfied, the distance measurement section detects the light reception timing of the reflected light pulse signal on the basis of the first electric signal or the second electric signal selected by the signal selection section.
(13) The distance measurement device according to (12), further including
a first distance determination section that determines whether or not the distance of the object measured by the distance measurement section is less than a reference value,
in which the predetermined condition is satisfied in a case where the first distance determination section determines that the distance is less than the reference value.
(14) The distance measurement device according to (12), further including
a second distance determination section that determines whether or not the distance of the object is greater than or equal to a reference value on the basis of a moving speed of a moving body including the light emitting section, the light scanning section, and the light receiving section,
in which the predetermined condition is satisfied in a case where the second distance determination section determines that the distance is less than the reference value.
(15) The distance measurement device according to any one of (11) to (14), in which
the distance measurement section alternately switches every predetermined time whether to detect the light reception timing of the reflected light pulse signal on the basis of the first electric signal or the second electric signal selected by the signal selection section or to detect the light reception timing of the reflected light pulse signal received by the light receiving section.
(16) The distance measurement device according to any one of (11) to (15), in which
the distance measurement section detects the light reception timing of the reflected light pulse signal received by the light receiving section in a case where the light scanning section scans the light pulse signal within a narrow angle range narrower than the predetermined angle range based on a center angle within the predetermined angle range, and detects the light reception timing of the reflected light pulse signal on the basis of the first electric signal or the second electric signal selected by the signal selection section in a case where the light scanning section scans the light pulse signal outside the narrow angle range.
(17) The distance measurement device according to (11), in which
the light receiving section includes a plurality of light receiving elements located within the light receiving area extending in the first direction and a second direction intersecting the first direction,
the acquisition section repeats a plurality of times along the second direction within the light receiving area a process of simultaneously acquiring the first electric signal in response to the reflected light pulse signal received at a central portion in the first direction of the light receiving area and the second electric signal in response to the reflected light pulse signal received at a position shifted in the first direction from the central portion in the first direction, and
the signal selection section repeats by a number of the light receiving elements arranged in the second direction of the light receiving area a process of selecting the first electric signal or the second electric signal for each light receiving element group arranged in the first direction within the light receiving area.
(18) The distance measurement device according to (17), in which
the acquisition section acquires the second electric signal by controlling the position shifted in the first direction from the central portion in the first direction for each light receiving element group arranged in the second direction within the light receiving area.
(19) The distance measurement device according to any one of (11) to (18), further including
a histogram generation section that generates a histogram representing a time frequency distribution of the light reception timing of the reflected light pulse signal on the basis of the first electric signal,
in which the determination section determines that the light reception timing of the reflected light pulse signal cannot be specified on the basis of the first electric signal in a case where the histogram is saturated.
(20) The distance measurement device according to (19), in which
before distance measurement by the distance measurement section is started, the signal selection section causes the light emitting section to emit the light pulse signal of a smaller number of times of light emission than a number of times of light emission at a time of the distance measurement by the distance measurement section, determines whether or not the histogram is saturated, selects the first electric signal when the histogram is not saturated, and selects the second electric signal in a case where the histogram is saturated.

Aspects of the present disclosure are not limited to the above-described individual embodiments, but include various modifications that can be conceived by those skilled in the art, and the effects of the present disclosure are not limited to the above-described contents. That is, various additions, modifications, and partial deletions are possible without departing from the conceptual idea and spirit of the present disclosure derived from the matters defined in the claims and equivalents thereof.

### REFERENCE SIGNS LIST

1 Distance measurement device
2 Light emitting section
3 Distance measurement section
4 Overall control section
5 Light receiving section
5a Light receiving range
5b Pixel group
5r Light receiving area
10 Object
11 Light emitting element
11g Light emitting element group
12 Light scanning section
12r Scanning range
13 Drive circuit
14 Clock generation section
15 Light emission control section
18 Reference pixel
20 Distance measurement pixel
21 Pixel array section
22 Distance measurement processing section
23 Control section
24 Clock generation section
25 Light emission timing control section
26 Drive circuit
30 Light receiving element
30g Light receiving element group
31 Time digital converter (TDC)
32 Histogram generation section
33 Signal processing section
33a Distance measurement section
33b First distance determination section
33c Second distance determination section
33d Acquisition section
33e Determination section
33f Signal selection section
34 Distance measurement control section
35 Output buffer
36 Lens
37 Lens
41 Polygon mirror
41m Reflective mirror surface
42 Rotation shaft
43 Motor
44 Mirror member
45 Distance measurement disabled area

1. A distance measurement device comprising:
a light emitting section that periodically emits a light pulse signal;
a light scanning section that scans the light pulse signal within a predetermined angle range;
a light receiving section including a light receiving area that receives a reflected light pulse signal reflected by an object irradiated with the light pulse signal;
a distance measurement section that measures a distance of the object on a basis of a light emission timing of the light pulse signal and a light reception timing of the reflected light pulse signal; and
a control section that determines whether or not to shift the light receiving area that receives the reflected light pulse signal in a predetermined direction according to the distance of the object.

2. The distance measurement device according to claim 1, wherein
the light emitting section and the light receiving section are disposed to be shifted from each other in the predetermined direction, and
the control section shifts the light receiving area in the predetermined direction when the distance of the object is less than or equal to a predetermined value.

3. The distance measurement device according to claim 1, wherein
the light emitting section and the light receiving section are disposed to be shifted from each other in the predetermined direction, and
in a case where the distance of the object is less than or equal to a predetermined value, the control section shifts the light receiving area in the predetermined direction more largely than a case where the distance of the object is larger than the predetermined value.

4. The distance measurement device according to claim 1, wherein
the light emitting section includes a plurality of light emitting elements arranged along the predetermined direction,
the plurality of light emitting elements emits the light pulse signal while shifting a time of each of a plurality of light emitting element groups each including two or more light emitting elements arranged adjacent to each other along the predetermined direction,
the light receiving section includes a plurality of light receiving elements arranged along the predetermined direction,
the plurality of light receiving elements receives the reflected light pulse signal based on the light pulse signal emitted by the corresponding light emitting element group in each of a plurality of light receiving element groups each including two or more light receiving elements arranged adjacent to each other along the predetermined direction, and
the control section determines whether or not to shift positions of the plurality of light receiving element groups that receives the reflected light pulse signal along the predetermined direction according to the distance of the object.

5. The distance measurement device according to claim 4, wherein the control section selects one of a first mode in which the positions of the plurality of light receiving element groups are shifted in the predetermined direction and a second mode in which the positions of the plurality of light receiving element groups are not shifted in the predetermined direction on a basis of a predetermined condition.

6. The distance measurement device according to claim 5, further comprising
a first distance determination section that determines whether or not the distance of the object measured by the distance measurement section is less than a reference value,
wherein the control section selects the first mode when the first distance determination section determines that the distance of the object is less than the reference value, and selects the second mode when the first distance determination section determines that the distance of the object is greater than or equal to the reference value.

7. The distance measurement device according to claim 5, further comprising
a second distance determination section that determines whether or not the distance of the object is greater than or equal to a reference value on a basis of a moving speed of a moving body including the light emitting section, the light scanning section, the light receiving section, and the control section,
wherein the control section selects the first mode when the second distance determination section determines that the distance of the object is less than the reference value, and selects the second mode when the second distance determination section determines that the distance of the object is greater than or equal to the reference value.

8. The distance measurement device according to claim 5, wherein the control section alternately selects the first mode or the second mode every predetermined time.

9. The distance measurement device according to claim 5, wherein the control section selects the second mode in a case where the light scanning section scans the light pulse signal within a narrow angle range narrower than the predetermined angle range based on a center angle within the predetermined angle range, and selects the first mode in a case where the light scanning section scans the light pulse signal outside the narrow angle range.

10. The distance measurement device according to claim 5, wherein before distance measurement by the distance measurement section is started, the control section causes the light emitting section to emit the light pulse signal of a smaller number of times of light emission than a number of times of light emission at a time of the distance measurement by the distance measurement section, and selects the first mode or the second mode on a basis of a result of measuring the distance of the object in advance.

11. A distance measurement device comprising:
a light emitting section that periodically emits a light pulse signal;
a light scanning section that scans the light pulse signal within a predetermined angle range;
a light receiving section including a light receiving area that receives a reflected light pulse signal reflected by an object irradiated with the light pulse signal;
a distance measurement section that measures a distance of the object on a basis of a light emission timing of the light pulse signal and a light reception timing of the reflected light pulse signal;
an acquisition section that simultaneously acquires a first electric signal received at a central portion of the light receiving area in a first direction and a second electric signal received at a position shifted in the first direction from the central portion of the light receiving area;
a determination section that determines whether or not the light reception timing of the reflected light pulse signal can be specified on a basis of the first electric signal; and
a signal selection section that selects the first electric signal or the second electric signal on a basis of a determination result of the determination section,
wherein the distance measurement section detects the light reception timing of the reflected light pulse signal on a basis of the first electric signal or the second electric signal selected by the signal selection section.

12. The distance measurement device according to claim 11, wherein
the light receiving section includes a plurality of light receiving elements located within the light receiving area extending in the first direction and a second direction intersecting the first direction,
in a case where a predetermined condition is satisfied, the acquisition section simultaneously acquires the first electric signal in response to the reflected light pulse signal received by two or more of the light receiving elements within a light receiving range extending in the second direction at a central portion of the light receiving area in the first direction and the second electric signal in response to the reflected light pulse signal received by two or more of the light receiving elements within a light receiving range extending in the second direction at a position shifted in the first direction from the central portion of the light receiving area, and
in a case where the predetermined condition is satisfied, the distance measurement section detects the light reception timing of the reflected light pulse signal on a basis of the first electric signal or the second electric signal selected by the signal selection section.

13. The distance measurement device according to claim 12, further comprising
a first distance determination section that determines whether or not the distance of the object measured by the distance measurement section is less than a reference value,
wherein the predetermined condition is satisfied in a case where the first distance determination section determines that the distance is less than the reference value.

14. The distance measurement device according to claim 12, further comprising
a second distance determination section that determines whether or not the distance of the object is greater than or equal to a reference value on a basis of a moving speed of a moving body including the light emitting section, the light scanning section, and the light receiving section,
wherein the predetermined condition is satisfied in a case where the second distance determination section determines that the distance is less than the reference value.

15. The distance measurement device according to claim 11, wherein the distance measurement section alternately switches every predetermined time whether to detect the light reception timing of the reflected light pulse signal on a basis of the first electric signal or the second electric signal selected by the signal selection section or to detect the light reception timing of the reflected light pulse signal received by the light receiving section.

16. The distance measurement device according to claim 11, wherein the distance measurement section detects the light reception timing of the reflected light pulse signal received by the light receiving section in a case where the light scanning section scans the light pulse signal within a narrow angle range narrower than the predetermined angle range based on a center angle within the predetermined angle range, and detects the light reception timing of the reflected light pulse signal on a basis of the first electric signal or the second electric signal selected by the signal selection section in a case where the light scanning section scans the light pulse signal outside the narrow angle range.

17. The distance measurement device according to claim 11, wherein
the light receiving section includes a plurality of light receiving elements located within the light receiving area extending in the first direction and a second direction intersecting the first direction,
the acquisition section repeats a plurality of times along the second direction within the light receiving area a process of simultaneously acquiring the first electric signal in response to the reflected light pulse signal received at a central portion in the first direction of the light receiving area and the second electric signal in response to the reflected light pulse signal received at a position shifted in the first direction from the central portion in the first direction, and
the signal selection section repeats by a number of the light receiving elements arranged in the second direction of the light receiving area a process of selecting the first electric signal or the second electric signal for each light receiving element group arranged in the first direction within the light receiving area.

18. The distance measurement device according to claim 17, wherein the acquisition section acquires the second electric signal by controlling the position shifted in the first direction from the central portion in the first direction for each light receiving element group arranged in the second direction within the light receiving area.

19. The distance measurement device according to claim 11, further comprising
a histogram generation section that generates a histogram representing a time frequency distribution of the light reception timing of the reflected light pulse signal on a basis of the first electric signal,
wherein the determination section determines that the light reception timing of the reflected light pulse signal cannot be specified on a basis of the first electric signal in a case where the histogram is saturated.

20. The distance measurement device according to claim 19, wherein before distance measurement by the distance measurement section is started, the signal selection section causes the light emitting section to emit the light pulse signal of a smaller number of times of light emission than a number of times of light emission at a time of the distance measurement by the distance measurement section, determines whether or not the histogram is saturated, selects the first electric signal when the histogram is not saturated, and selects the second electric signal in a case where the histogram is saturated.
